(19) United States
(12) Patent Application Publication
(10) Pub. No.: US 2018/0053448 A1
(43) Pub. Date: Feb. 22, 2018

(54) GRAPHIC DISPLAY SYSTEM AND RELATED METHOD

(71) Applicant: Benjamin FEIN, Wayne, PA (US)

(72) Inventor: Benjamin FEIN, Wayne, PA (US)

(21) Appl. No.: 15/679,354

(22) Filed: Aug. 17, 2017

Related U.S. Application Data
(60) Provisional application No. 62/440,592, filed on Dec. 30, 2016.
(60) Provisional application No. 62/377,936, filed on Aug. 22, 2016.

(51) Int. Cl. G09F 7/18; B32B 3/02; B32B 7/12

(52) U.S. Cl. CPC G09F 7/18; G09F 2007/1852; B32B 7/12; B32B 3/02

(57) ABSTRACT

A graphic display system includes a substrate base and a first graphic layer selectively and repeatably, removably attachable atop the substrate base. A trim is edge banded around the perimeter of the substrate base, the trim defining a height substantially equivalent to a combined thickness of the substrate base and the first graphic layer. The trim extends beyond the top surface of the substrate base and defines a cavity atop the substrate base for selectively and repeatably, removably receiving the first graphic layer therein. The perimeter of the first graphic layer is also edge banded by the trim when received within the cavity.

### CROSS-REFERENCE TO RELATED APPLICATIONS

This application claims priority from U.S. Provisional Patent Application No. 62/377,936, titled “Graphic Display System and Related Method”, filed on Aug. 22, 2016, and U.S. Provisional Patent Application No. 62/440,592, titled “Graphic Display System and Related Method”, filed on Dec. 30, 2016, the contents of each of which are incorporated by reference in their entireties herein.

### BACKGROUND OF THE INVENTION

The present invention is generally directed to graphic displays and, more particularly, to a reusable graphic display system.

Conventional graphic displays comprise a substrate base/panel having an edge banded trim that is cut flush with the top face of the substrate, and a graphic that is permanently affixed atop the face of the base substrate. In one form, the graphic may be directly printed onto the face of the substrate base. Alternatively, the graphic may take the form of an individually printed sheet that is permanently affixed to the face of the substrate base, e.g., via lamination, adhesive, fasteners, or the like.

One drawback associated with conventional graphic displays is that the face of the graphic is unprotected, which exposes the face to damage. Where a printed sheet is used, the edges thereof are also exposed because the edge banded trim of the substrate base only reaches the top face thereof. Thus, the edges of the graphic sheet are also subject to damage and/or peeling. For example, graphic displays are often damaged during transportation to a retailer/consumer. Shifting boxes and other movements can scratch the graphics during shipping. In retail environments, the graphics may be damaged where heavy equipment, such as a forklift, is used to move the graphics. Where a printed sheet is utilized, the sheet can delaminate from the substrate base and/or tear. Over time, for example, the edges of the graphic sheet may begin to peel away from the underlying substrate base. Often, this may be caused from exposure of the adhesive to air and subsequent drying out.

Another drawback associated with conventional graphic displays is the permanent affixation of the graphic to the underlying substrate base. Accordingly, damage to the graphic layer requires replacement of the entire graphic display, i.e., the graphic layer and substrate base, which requires commitment of additional resources to remanufacture, reship and reinstall a replacement graphic display, as well as disposal of the original damaged display. Any update or change to the graphic display also requires the same commitment of additional resources to remanufacture, reship and reinstall. Time and cost associated with these resources is borne by the retailer/consumer.

Therefore, it would be advantageous to manufacture a graphic display system having a reusable substrate base and a replaceable graphic layer removably attached thereto.

### BRIEF SUMMARY OF THE INVENTION

Briefly stated, one aspect of the present invention is directed to a graphic display system. The display system comprises a substrate base having a top surface, a bottom surface and peripheral sides, the peripheral sides defining a perimeter of the substrate base. A first graphic layer has a top surface, a bottom surface and peripheral sides, the peripheral sides of the first graphic layer defining a perimeter thereof. The first graphic layer is selectively and repeatably, removably attachable atop the substrate base. A trim is edge banded around the perimeter of the substrate base, the trim defining a height substantially equivalent to a combined thickness of the substrate base and the first graphic layer. The trim thus extends beyond the top surface of the substrate base and defines a cavity atop the substrate base for selectively and repeatably, removably receiving the first graphic layer therein. The perimeter of the first graphic layer is also edge banded by the trim when received within the cavity.

Another aspect of the present invention is directed to a method of manufacturing and assembling a graphic display system. The method comprises the steps of edge banding a trim around a perimeter of a substrate base, the trim defining a height substantially equivalent to a combined thickness of the substrate base and a first graphic layer to be placed atop the substrate base, thereby defining a cavity atop the substrate base; and inserting the first graphic layer into the cavity, the first graphic layer being selectively and repeatably, removably secured atop the substrate base.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a top plan view of a graphic display system in accordance with a first preferred embodiment of the present invention;

FIG. 2 is an enlarged side elevational, cross-sectional view of an embodiment of the graphic display system of FIG. 1, taken along the sectional line 2-2, with an exploded side illustrating a substrate base of the system having a magnetic layer and a clear graphic layer of the system with a second surface graphic print thereon and an underlying iron ferrous layer for removable magnetic attachment to the substrate base;

FIG. 3 is an enlarged side elevational, cross-sectional view of an alternative embodiment of the graphic display system of FIG. 1, taken along the sectional line 2-2, with an exploded side illustrating an opaque graphic layer of the system with a first surface graphic print thereon and an underlying removable adhesive layer for removable adhesion to the substrate base;

FIG. 4 is an enlarged side elevational, cross-sectional view of a second preferred embodiment of the graphic display system, taken along the sectional line 2-2, with an exploded side showing individual components of the system; and

FIG. 5 is an enlarged side elevational, cross-sectional view of a third preferred embodiment of the graphic display system, taken along the sectional line 2-2, with an exploded side showing individual components of the system.

### DESCRIPTION OF THE INVENTION

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the graphic display system, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

It should also be understood that the terms “about,” “approximately,” “generally,” “substantially” and like terms, used herein when referring to a dimension or characteristic of a component of the invention, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

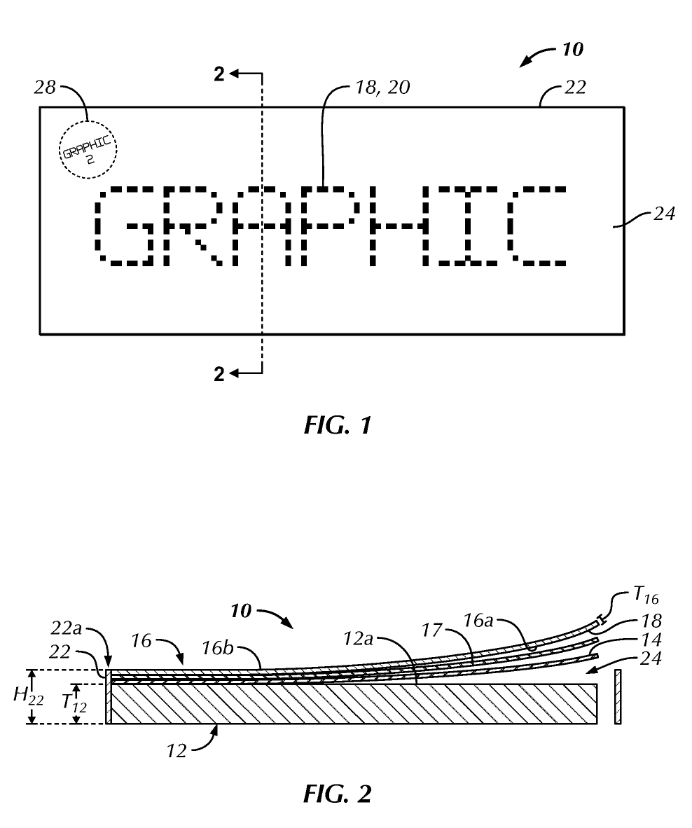

Referring to the drawings in detail, wherein like numerals indicate like elements throughout, there is shown in FIGS. 1-3 a graphic display system, generally designated 10, in accordance with a first preferred embodiment of the present invention. As shown in FIGS. 2 and 3, the graphic system 10 generally includes a substrate base/panel 12 and a graphic layer 16, 16′ selectively, i.e., at the discretion of a user, and repeatably removably attachable thereto, as will be described in further detail below.

In one embodiment, the substrate base 12 is constructed of particle board, but is not so limited. For example, without limitation, the substrate base 12 may be constructed of medium-density fiberboard (“MDF”), hardboard, polystyrene foam, or foam board. The substrate base 12 may also be polymeric, constructed of, for example, without limitation, polyvinyl chloride (“PVC”), expanded PVC, or the like. As should be understood by those of ordinary skill in the art, however, the substrate base 12 may alternatively be constructed of any material, currently known or that later becomes known, capable of performing the functions of the substrate base 12 described herein and capable of undergoing the manufacturing process described herein. A thickness T₁₂ of the substrate base 12 may range between approximately 0.1875 inch and approximately 3.0 inches.

In the illustrated embodiment of FIG. 2, the graphic layer 16 comprises a clear layer. For example, without limitation, the clear graphic layer 16 may be constructed of acrylic, polycarbonate, polyester, polyethylene terephthalate (“PETG”), vinyl or the like. A thickness T₁₆ of the clear graphic layer 16 may range between approximately 0.002 inch and approximately 0.125 inch. The clear graphic layer 16 includes a second surface printed graphic 18, e.g., a sign, thereon. That is, the graphic 18 is printed on the underside 16a of the clear layer 16. As should be understood by those of ordinary skill in the art, the second surface graphic print 18 may include an area-coat print, e.g., a white area-coat print, therewith.

Textured coatings may optionally also be added to the top surface 16b of the clear graphic layer 16. For example, matte, velvet or satin coatings may be applied. An anti-graffiti hard coat may also be applied to the clear graphic layer 16 to further protect against damage and/or graffiti. As should be understood by those of ordinary skill in the art, however, the graphic layer 16 itself protects the second surface graphic print 18 on the underside thereof.

In the illustrated embodiment of FIG. 3, the graphic layer 16′ comprises an opaque layer. For example, without limitation, the opaque graphic layer 16′ may be constructed of polystyrene, vinyl, PVC, high density polyethylene (“HDPE”), polypropylene, foam board, display board, corrugated, or the like. A thickness T_{16′} of the graphic layer 16′ is substantially the same as the thickness T₁₆ of the clear graphic layer 16, i.e., may range between approximately 0.002 inch and approximately 0.125 inch. The opaque graphic layer 16′ includes a first surface printed graphic 20 thereon. That is, the graphic 20 is printed on the top face 16′b of the opaque layer 16′. A protective clear coat may be applied to the top face of the first surface printed graphic 20, e.g., a UV clear hard coat, to shield the graphic 20. Similarly to the graphic layer 16, various coatings may optionally also be added atop the graphic 20. For example, high gloss, matte, or satin coatings may be applied over the graphic 20. An anti-graffiti hard coat may also be applied atop the graphic 20 to further protect against damage and/or graffiti.

To further protect the graphic layer 16, 16′, an edge banded trim 22 extends around the perimeter of the entire graphic display system 10. That is, the edge banded trim 22 is advantageously sized and dimensioned to cover the peripheral sides around the perimeter of both the substrate base 12 and the graphic layer 16, 16′. As shown in FIGS. 2 and 3, the upper end 22a extends at least substantially flush with, or slightly beyond, the top face 16b, 16′b of the graphic layer 16, 16′. A height H₂₂ of the trim 22 may range between approximately 0.015 inch and approximately 0.1875 inch.

Advantageously, utilizing a second surface printed graphic 18 or a first surface printed graphic 20 having a protective coat thereon, in combination with the extension of the trim 22 around the peripheral perimeter of the graphic layer 16, 16′, protects the graphic layer 16, 16′, including the respective printed graphics 18, 20, along all of the otherwise exposed sides, i.e., the top face and the peripheral sides along the perimeter. Accordingly, the risk of damage to the graphic layer 16, 16′ is greatly reduced, e.g., during shipment, installment, and subsequent use.

The extension of the height H₂₂ of the trim 22 (which wraps around the perimeter of the substrate base 12 as shown in FIG. 1) beyond, i.e., above, the top surface of the substrate base 12 also advantageously defines a cavity 24 for removably receiving the graphic layer 16, 16′, and facilitating proper alignment of the graphic layer 16, 16′ atop the substrate base 12.

In the illustrated embodiment of FIG. 2, the graphic layer 16 is selectively and repeatably, magnetically removably attachable to the substrate base 12. As shown in FIG. 2, a pressure sensitive magnetic film 14 is applied or lined to the face 12a of the substrate base 12. For example, without limitation, the magnetic film 14 may be laminated, screen printed, or otherwise adhered to the face 12a. An opposing iron ferrous layer 17, attracted to the magnetic film 14, is applied or lined to the underside 16a of the graphic layer 16, via, for example, without limitation, lamination, screen printing or the like. Accordingly, when the graphic layer 16 is placed in the cavity 24, the iron ferrous layer 17 removably, magnetically attaches the graphic layer 16 to the substrate base 12. The cavity 24 also automatically aligns the graphic layer 16 with the substrate base 12 such that the graphic layer 16 does not visibly appear to be removable. As should be understood by those of ordinary skill of the art, the graphic layer 16′ may also be magnetically removably attached to the substrate base 12 as well.

Alternatively, in the illustrated embodiment of FIG. 3, the underside of the graphic layer 16′ is coated with removable adhesive 26, such as, for example, without limitation, a pressure sensitive adhesive or a low tack adhesive layer. Accordingly, the graphic layer 16′ is repeatably removably adherable to the substrate base 12. As should be understood by those of ordinary skill of the art, the graphic layer 16 may also be removably adhered to the substrate base 12 via removable adhesive. As should also be understood by those of ordinary skill in the art, the disclosure is not so limited to magnetic or removable adhesive attachment. Rather, the graphic layer 16, 16′ may be repeatably removably attachable to the substrate base 12 via any of numerous different methods, currently known or that later become known.

The edge banding trim 22 may be formed of at least one of PVC, acrylic, plastic, wood or the like. Alternatively, the edge banding trim 22 may be formed of a magnetic or magnetic receptive material such as, for example, at least one of steel, stainless steel, magnetic film or the like. Advantageously, the use of a magnetic or magnetic receptive material for the edge banding trim 22 will further assist in removably securing the graphic layer 16, 16′ on the substrate base 12 in the cavity 24. For example, if the edge banding trim 22 is formed of a magnetic receptive material (e.g., steel, RubberSteel® manufactured by Magnum Magnetics Corporation, iron ferrous or the like) the peripheral edges of the graphic layer 16, 16′ formed of a magnetic film would be attracted to the edge banding trim 22. Conversely, if the edge banding trim 22 was formed of a magnetic film, the graphic layer 16, 16′ would be formed of a magnetic receptive film, which would be attracted to the magnetic edge banding trim 22.

To manufacture the graphic display system 10, the substrate base 12 is cut to the desired size and then edge banded with the trim 22. In embodiments where a magnetic film 14 is utilized, the magnetic film is applied to the substrate base 12. As should be understood by those of ordinary skill in the art, the magnetic film 14 may be applied to the substrate base 12 before or after cutting the substrate base 12 to the desired size.

In one embodiment, the height H₂₂ of the trim 22 is set to be greater than the thickness T₁₂ of the substrate base 12 by a length substantially equivalent to, or slightly greater than, the thickness T₁₆, T_{16′} of the graphic layer 16, 16′. That is, when the trim 22 is edge banded to the substrate base 12, the trim 22 extends beyond, i.e., above, the sides of the substrate base 12. Thus, after the substrate base 12 is edge banded with the trim 22, in a manner well understood by those of ordinary skill in the art, the cavity 24 is formed atop the substrate base 12 for removably receiving the graphic layer 16, 16′ therein.

Alternatively, to edge band the substrate base 12 with the trim 22, a temporary graphic layer 16, 16′, having a thickness equal to the thickness T₁₆, T_{16′} of the graphic layer 16, 16′, may be removably placed atop the substrate base 12 during the edge banding process. The substrate base 12 and the temporary graphic layer 16, 16′ are then edge banded in a manner well understood by those of ordinary skill in the art. As shown in FIGS. 1-3, the trim 22 extends/wraps around the perimeter of both the substrate base 12 and the temporary graphic layer 16, 16′. The presence of the temporary layer 16, 16′ allows the height H₂₂ of the trim 22 to be cut substantially flush with, or slightly higher than, the thickness T₁₂ of the substrate base 12 and the actual graphic layer 16, 16′ without risking damage to the actual graphic layer 16, 16′. Thus, the height H₂₂ of the trim 22 extends from the base of the substrate layer 12 to the top of the graphic layer 16, 16′. Upon completion of the edge banding process, the temporary graphic layer 16, 16′ is removed, vacating the cavity 24 defined by the top of the substrate base 12 and the trim 22.

Thereafter, actual graphic layers 16, 16′, i.e., to be purchased, correspondingly sized and shaped to cavity 24 may be removably inserted therein. Due to the substantially complementary fit between the graphic layer 16, 16′ and the cavity 24 atop the substrate base 12, and the trim 22 being substantially flush with the face of the graphic layer 16, 16′, the graphic layer 16, 16′ appears to be permanently attached to the substrate base 12. A tool, such as, for example, without limitation, a utility knife, may be necessary to remove the graphic layer 16, 16′ from the cavity 24.

As previously explained, one advantage of the graphic display system 10 over conventional graphic displays is the added protection to the top and side surfaces of the graphic layer 16, 16′ during the lifespan of use thereof. Additionally, costs associated with the graphic display system 10 are reduced over conventional graphic displays. For example, replacement of the graphics, e.g., to update the graphic, merely requires manufacture of a new graphic layer 16, 16′ for the graphic display system 10, rather than replacement of the entire graphic display (substrate base and graphic). Accordingly, consumers/retailers can more frequently economically update their graphics, e.g., signs. Likewise, costs associated with shipping and installing replacement graphics are also reduced. The carbon footprint of the graphic display system 10 is also greatly reduced over conventional graphic displays because the majority of the graphic display system 10 is reusable, i.e., only the graphic layer 16, 16′ needs to be replaced to change the graphic 18, 20.

An additional advantage of the graphic display system 10 is that multiple graphic layers 16, 16′ may be readily removably placed/stacked atop one another. For example, without limitation, where the substrate base 12 includes a magnetic film 14, and a first graphic layer 16 (e.g., having an iron ferrous layer 17) is removably placed in the cavity 24, a second graphic layer 28 (e.g., also having an iron ferrous layer) may be removably placed atop the first graphic layer 16. The second graphic layer may be smaller than or the same size as the first graphic layer 16. For example, a temporary advertising message, such as, without limitation, “sale”, “special offer” or “new product announcement”, may be added as a smaller second graphic layer 28 atop the first graphic layer 16. The magnetic attraction between the magnetic film 14 and the iron ferrous layer of the second graphic layer 28 repeatably, removably attaches the second graphic layer 28 atop the first graphic layer 16. Alternatively, the second graphic layer 24 may be removably attached the first graphic layer 16, 16′ via a pressure sensitive or low tack adhesive or the like. Accordingly, the graphic display system 10 is easily customizable and the consumer/retailer may add desired dimensional design elements to the first graphic layer 16, 16′.

Optionally, e.g., if a consumer/retailer prefers, the graphic display system 10 may be modified such that the graphic layer 16, 16′ is permanently attached to the substrate base 12. For example, without limitation, the graphic layer 16, having a second surface printed graphic 18, may be permanently attached to the substrate base 12 in a manner well understood by those of ordinary skill in the art, e.g., via permanent adhesive. A protective release liner may be temporarily affixed to the graphic layer 16 for protection from damage during the edge banding process. The substrate base 12 and actual graphic layer 16 are then edge banded in a manner well understood by those of ordinary skill in the art, such that the height H₂₂ of the trim 22 extends from the base of the substrate layer 12 to the top of the graphic layer 16, as previously explained.

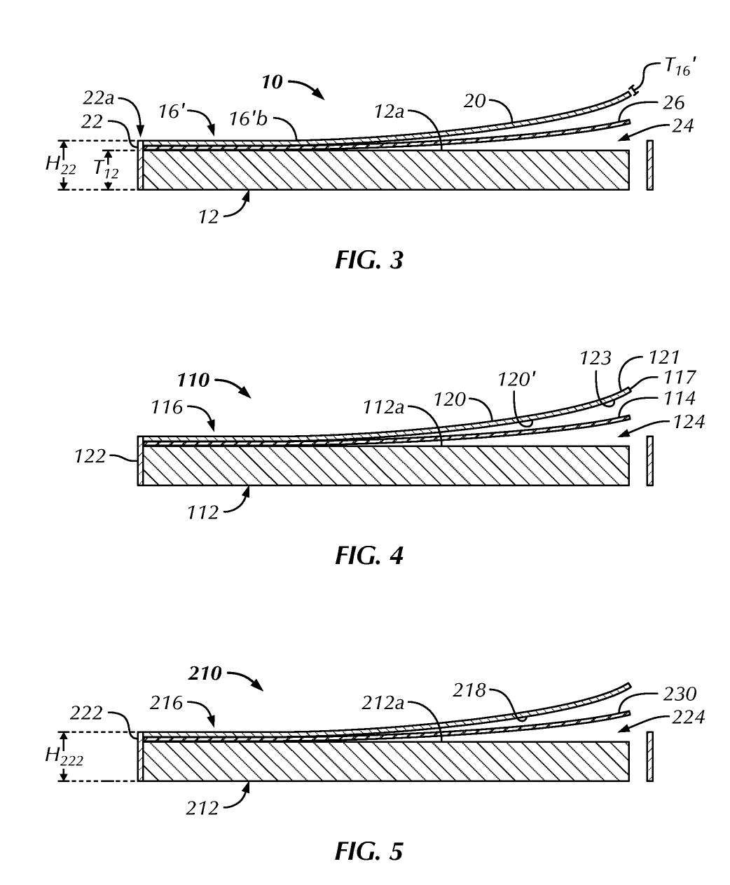

FIG. 4 illustrates a second embodiment of the graphic display system 110. The reference numerals of the present embodiment are distinguishable from those of the above-described embodiment by a factor of one-hundred (100), but otherwise indicate the same elements as indicated above, except as otherwise specified. The graphic display system 110 of the present embodiment is substantially similar to that of the earlier embodiment. Therefore, the description of certain similarities between the embodiments may be omitted herein for the sake of brevity and convenience, and, therefore, is not limiting.

A primary difference between the graphic display systems 10 and 110 is that the graphic layer 116 takes the form of a double sided receptive magnetic layer, having two first surface printed graphics 120, 120′ thereon, a front face print on a top side of the graphic layer 116 and a back face print on the opposing underside of the graphic layer 116. The two first surface printed graphics 120, 120′ may be different graphics.

In the illustrated embodiment shown in FIG. 4, for example, the graphic layer 116 may take the form of a double sided magnetic-receptive film having an iron ferrous middle layer 117, an opaque print receptive top surface layer 121, e.g., a white print receptive surface, and an opaque print receptive bottom surface layer 123, e.g., another white print receptive surface. The two print receptive surfaces 121, 123, sandwiching the iron ferrous middle layer 117, may be laminated together. Alternatively, the iron ferrous middle layer 117 may have the print receptive surfaces 121, 123 screen printed or coated thereon. As one example, the coated film 121, 123 on the outside of the iron ferrous layer 117 may be polyester or polypropylene. White polyester film is suitable for high gloss graphics and where heat stability is important. Polypropylene film is suitable for lower gloss graphics. More generally, the opaque print receptive surface layers 121, 123 may be constructed of polystyrene, vinyl, PVC, HDPE, polypropylene, foam board, display board, corrugated, or the like, but are not so limited. Fabric-based and/or textured magnetic receptive film may also be employed.

The first surface graphics 120, 120′ may be printed on the print receptive surfaces 121, 123, respectively. A protective clear coat may be applied to the graphics 120, 120′, and various coatings may optionally also be added atop the graphics. In use, the graphic layer 116 may be removably inserted into the cavity 124 with either of the graphics 120, 120′ facing outward, and the graphic layer 116 may be selectively removed from the cavity 124 and removably reinserted therein with the other of the graphics 120, 120′ facing outward.

FIG. 5 illustrates a third embodiment of the graphic display system 210. The reference numerals of the present embodiment are distinguishable from those of the above-described embodiments by a factor of two-hundred (200), but otherwise indicate the same elements as indicated above, except as otherwise specified. The graphic display system 210 of the present embodiment is substantially similar to that of the earlier embodiments. Therefore, the description of certain similarities between the embodiments may be omitted herein for the sake of brevity and convenience, and, therefore, is not limiting.

A primary difference between the graphic display systems 10, 110 and the graphic display system 210 is that the cavity 224 may additionally include a backlight (as will be described further below), audio electronics, video electronics, touchpad electronics, or a combination thereof, received therein. The graphic layer 216 may also include an aperture (not shown), for example, for accessing the underlying audio, video and/or the touchpad electronics.

As shown in FIG. 5, the height H₂₂₂ of the trim 222 extends further beyond the substrate base 212 than in the embodiments of FIGS. 1-4 to accommodate the additional components within the cavity 224. For example, the height H₂₂₂ of the trim 222 may range between approximately 0.25 inch and approximately 2 inches, and, more preferably, between approximately 0.75 inch and approximately 1 inch, but the disclosure is not so limited. As should be understood by those of ordinary skill in the art, the height H₂₂₂ of the trim 222 may alternatively be shorter or longer according to the components housed within the cavity 224. In one embodiment, the trim 222 also defines a thickness ranging between approximately 0.020 mm to approximately 3 mm, such as, for example, approximately 1 mm.

As shown in FIG. 5, the cavity 224 includes a light panel 230 (single or double sided) received therein, serving as a backlight for the graphic layer 216. As one example, the light panel 230 may take the form of an LED panel, e.g., an edge lit LED panel having an LED Ribbon light source. The LEDs may be mounted on a side of an acrylic panel, e.g., having a thickness of approximately 0.25 inch, which diffuses the light. The acrylic panel may extend along one or more side edges of the cavity 224, or along the entire periphery of the cavity 224. Alternatively, the LEDs may be dispersed throughout a backer panel, occupying substantially the full surface area of the cavity 244. As should be understood by those of ordinary skill in the art, however, the light panel 230 may take the form of other light sources, currently known or that later become known. For example, without limitation, the backlight may take the form of an array of individual light sources (not shown) dispersed within the cavity 224.

The light panel 230 may be secured in the cavity 224 via a friction fit, adhesive, or via another conventional manner known by those of ordinary skill in the art. The light panel 230 is also powered by a conventional power source, e.g., battery powered or via a power cord (not shown) connectable to an electrical power source, in a manner well understood by those of ordinary skill in the art.

The graphic layer 216 may take the form of a backlit color transparency film, such as, for example, without limitation, Duratrans® manufactured by the Eastman Kodak Company, with either a first or second surface graphic printed thereon, as previously described. The graphic layer 216 may also take the form of a clear or translucent plastic layer constructed of acrylic, styrene, polypropylene, polyester, vinyl, polycarbonate, PETG, or the like. A thickness of the graphic layer 216 may range, for example, between approximately 0.05 inch and approximately 0.125 inch, but the disclosure is not so limited. In one embodiment, the graphic layer 216 may include magnetic tape (not shown) extending around the periphery thereof, for removable attachment with the substrate base 212 when received within the cavity 224, atop the light panel 230. As should be understood, however, the graphic layer 216 may be removably securable in the cavity 224 via other means known by those of ordinary skill in the art, or that later become known.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

I/We claim:

1. A graphic display system comprising:
a substrate base having a top surface, a bottom surface and peripheral sides, the peripheral sides defining a perimeter of the substrate base;
a first graphic layer having a top surface, a bottom surface and peripheral sides, the peripheral sides of the first graphic layer defining a perimeter thereof, the first graphic layer being selectively and repeatably, removably attachable atop the substrate base; and
a trim edge banded around the perimeter of the substrate base, the trim defining a height substantially equivalent to a combined thickness of the substrate base and the first graphic layer;
the trim thereby extending beyond the top surface of the substrate base and defining a cavity atop the substrate base for selectively and repeatably, removably receiving the first graphic layer therein, the perimeter of the first graphic layer also being edge banded by the trim when received within the cavity.

2. The graphic display system of claim 1, wherein the first graphic layer is magnetically, removably attachable to the substrate base.

3. The graphic display system of claim 2, wherein the substrate base comprises a magnetic layer and the first graphic layer comprises an iron ferrous layer having magnetic attraction to the magnetic layer of the substrate base.

4. The graphic display system of claim 1, wherein the first graphic layer comprises a removable adhesive layer coating for removable attachment to the substrate layer.

5. The graphic display system of claim 4, wherein the removable adhesive coating comprises a low tack adhesive or a pressure sensitive adhesive.

6. The graphic display system of claim 1, wherein the first graphic layer comprises a clear layer having a second surface graphic printed thereon.

7. The graphic display system of claim 6, wherein the first graphic layer is constructed of acrylic, polycarbonate, polyester, PETG, or vinyl.

8. The graphic display system of claim 1, wherein the first graphic layer comprises an opaque layer having a first surface graphic printed thereon.

9. The graphic display system of claim 8, wherein the first graphic layer is constructed of polystyrene, vinyl, PVC, HDPE, polypropylene, foam board, display board, or corrugated.

10. The graphic display system of claim 8, further comprising a protective clear coat applied atop the first graphic layer.

11. The graphic display system of claim 1, further comprising a second graphic layer removably attached to the top surface of the first graphic layer.

12. The graphic display system of claim 1, wherein the first graphic layer includes a first surface graphic on a front surface thereof, and another first surface graphic on a back surface thereof.

13. The graphic display system of claim 12, wherein the first graphic layer comprises a double sided magnetic receptive layer having an iron ferrous middle layer, an opaque print receptive top surface layer and an opaque print receptive bottom surface layer.

14. A method of manufacturing and assembling a graphic display system comprising the steps of:
edge banding a trim around a perimeter of a substrate base, the trim defining a height substantially equivalent to a combined thickness of the substrate base and a first graphic layer to be placed atop the substrate base, thereby defining a cavity atop the substrate base; and
inserting the first graphic layer into the cavity, the first graphic layer being selectively and repeatably, removably secured atop the substrate base.

15. The method of claim 14, further comprising the steps of applying a magnetic film to the substrate base before the edge banding step, and applying an iron ferrous layer to the first graphic layer before the inserting step.

16. The method of claim 14, further comprising the step of applying a removable adhesive layer coating to the first graphic layer before the inserting step.

17. The method of claim 14, further comprising removably attaching a second graphic layer atop the first graphic layer.

18. The method of claim 14, wherein the edge banding step comprises edge banding the trim around the perimeter of the substrate base and a temporary layer removably attached atop the substrate base, the temporary layer being sized and dimensioned substantially equally to a size and dimension of the first, actual graphic layer;
and the method further comprising the step of removing the temporary graphic layer prior to the inserting step.
